(19) United States
(12) Patent Application Publication
(10) Pub. No.: US 2003/0113229 A1
(43) Pub. Date: Jun. 19, 2003

(54) Method for adhesion of polymers to metal-coated substrates

(76) Inventors: Natalia Briones, Chandler, AZ (US); Vi-En Choong, Chandler, AZ (US); W. Travis Johnson, Chandler, AZ (US)

Correspondence Address: FLEHR HOHBACH TEST ALBRITTON & HERBERT LLP, Four Embarcadero Center, Suite 3400, San Francisco, CA, 94111-4187, US

(21) Appl. No.: 09/962,913

(22) Filed: Sep. 24, 2001

Related U.S. Application Data
(63) Continuation-in-part of application No. 09/667,980, filed on Sep. 22, 2000.

(51) Int. Cl. G01N 31/22

(52) U.S. Cl. 422/57

(57) ABSTRACT

The present invention provides methods for improving the a&esion of gels to metalcoated substrates. In particular, the present invention provides a method comprising the steps of forming a thiol or disulfide self-assembled monolayer on the metal-coated substrate prior to deposition of the gel structures. The invention further provides devices fabricated according to the methods of the invention, comprising a substrate having a surface, a noble metal layer deposited on the substrate surface, a self-assembled monolayer comprised of bifunctional molecules having a thiol or disulfide end and a polymerizable end formed on the noble metal layer, and a plurality of gel pads a&Bred to the self-assembled monolayer. The devices of the invention are advantageously used for performing assays using optical and/or electrochemical detection methods.

This is a continuing application of U.S. Ser. No. 09/667,980, filed Sep. 22, 2000.

### BACKGROUND OF THE INVENTION

1. Field of the Invention

The present invention relates to the field of self-assembled monolayers. Specifically, the invention relates to methods of improving adhesion of polymers, including gels, to metal-coated substrates by forming stable thiol and disulfide self-assembled monolayers on the substrates.

2. Description of the Prior Art

Recent advances in molecular biology have provided the opportunity to identify pathogens, diagnose disease states, and perform forensic determinations using gene sequences specific for the desired purpose. This explosion of genetic information has created a need for high-capacity assays and equipment for performing molecular biological assays, particularly nucleic acid hybridization assays. Most urgently, there is a need to miniaturize, automate, standardize and simplify such assays. This need stems from the fact that while these hybridization assays were originally developed in research laboratories working with purified products and performed by highly skilled individuals, adapting these procedures to clinical uses, such as diagnostics, forensics and other applications, has produced the need for equipment and methods that allow less-skilled operators to effectively perform the assays under higher capacity, less stringent assay conditions.

Nucleic acid hybridization assays are advantageously performed using probe array technology, which utilizes binding of target single-stranded DNA onto immobilized DNA (usually, oligonucleotide) probes. The detection limit of a nucleic acid hybridization assay is determined by the sensitivity of the detection device, and also by the amount of target nucleic acid available to be bound to probes, typically oligonucleotide probes, during hybridization.

Existing electrical detection methods include the use of costly thin film transistors to site address biomolecules in an array format. See, e.g., PCT Publication WO 98/01758 to Nanogen entitled Multiplexed Active Biologic Array. As is well known in the art, other attempts to create electrical detection methods that use an array of gel pads on a surface composed of an electrode metal such as gold have been unsuccessful due to the tendency of the gel pads to delaminate from the metal-coated surface.

Thus, there remains a need in this art for low-cost assay devices incorporating polymer technology that allow the use of both optical and electrical detection methods. There further remains a need in the art for methods of manufacturing such low-cost assay devices incorporating polymer technology that do not fail as a result of delamination of the polymers or gel pads.

### SUMMARY OF THE INVENTION

The present invention solves the problems associated with the prior art by eliminating the need for costly thin film transistors to- site address biomolecules in an array format and by providing methods for preventing delamination of gel pads used in electrical or electrochemical detection assays. The invention advantageously provides improved methods for adhering polymeric layers, including gel pads, to a substrate surface, generally through the use of a SAM. The invention improves on existing biochip technology by reducing the complexity and cost of the manufacturing process by providing for the self-assembly of the thiol or disulfide monolayer. The invention also improves on existing biochip technology by allowing for electrical and electrochemical assays to be efficiently performed using hydrogel technology.

In a first aspect, the invention provides an improved method for adhering polymeric gel pads to a substrate surface comprising the steps of plating the substrate with a metal, forming a self-assembled monolayer of bifunctional molecules on the metal surface and polymerizing the gel pads on the self-assembled monolayer.

In preferred embodiments, the metal layer comprises a noble metal. In particularly preferred embodiments, the metal layer comprises a layer of gold. The metal layer is preferably thermally deposited on the substrate.

In further preferred embodiments, the bifunctional molecules forming the self-assembled monolayer comprise molecules having a thiol or disulfide end and a polymerizable end.

In further preferred embodiments, the gel pads of the present invention are polyacrylamide gel pads. In particularly preferred embodiments, the gel pads of the present invention are streptavidin-containing polyacrylamide gel pads.

In a second aspect, the invention provides electrical or electrochemical devices for detecting specific interactions between biomolecules manufactured according to the processes of the invention. In preferred embodiments, the devices comprise a substrate having a surface, a layer of metal deposited on the substrate surface, a self-assembled monolayer of bifunctional molecules formed on the metal layer, and a plurality of gel pads adhered to the self-assembled monolayer. A corresponding plurality of oligonucleotide probes are attached to the gel pads to provide the assay binding or interaction sites.

Specific preferred embodiments of the present invention will become evident from the following more detailed description of certain preferred embodiments and the claims.

### DESCRIPTION OF THE DRAWINGS

Presently preferred embodiments of the invention are described with reference to the following drawings.

FIG. 1 illustrates a self-assembled monolayer on a gold-coated substrate prepared according to the methods of the present invention.

FIG. 2 illustrates adhesion of gel pads to a gold-coated glass microscope slide having a self-assembled monolayer prepared according to the methods of the invention.

FIG. 3 illustrates adhesion of gel pads to a gold-coated glass microscope slide having a self-assembled monolayer prepared according to the methods of the invention in comparison to an uncoated portion of the glass microscope slide.

FIG. 4 depicts the synthesis of dipyrrole propylamide tartarate.

FIG. 5. depicts the synthesis of 4, 7, 10-trioxa-1,13-tridecanodipyrrole.

FIG. 6 depicts the synthesis of dipyrrole acetic 4, 7, 10-trioxa-1,13-tridecanodiamide.

FIG. 7 depicts the synthesis of thiopyrrole for thio-attached pyrrole.

### DESCRIPTION OF THE PREFERRED EMBODIMENTS

The present invention provides methods for improving the adhesion of polymers to metal coated substrates using self-assembled monolayers of bifunctional molecules. In particular, the present invention provides a method of forming a thiol or disulfide self-assembled monolayer on the substrate prior to deposition of the polymer structures, including both conjugated polymers, gel or hydrogel polymers, as well as other non-conjugated polymers. The invention further provides devices formed by using self-assembled monolayers of bifunctional molecules to adhere a plurality of polymer pads to a metal-coated substrate surface. The devices of the invention are advantageously used for performing assays using optical and/or electrical detection methods.

Accordingly, the present invention provides methods of detecting a target analyte in sample solutions. As will be appreciated by those in the art, the sample solution may comprise any number of things, including, but not limited to, bodily fluids (including, but not limited to, blood, urine, serum, lymph, saliva, anal and vaginal secretions, perspiration and semen, of virtually any organism, with mammalian samples being preferred and human samples being particularly preferred); environmental samples (including, but not limited to, air, agricultural, water and soil samples); biological warfare agent samples; research samples (i.e. in the case of nucleic acids, the sample may be the products of an amplification reaction, including both target and signal amplification as is generally described in PCT/US99/01705, such as PCR or SDA amplification reactions); purified samples, such as purified genomic DNA, RNA, proteins, etc.; raw samples (bacteria, virus, genomic DNA, etc.; As will be appreciated by those in the art, virtually any experimental manipulation may have been done on the sample.

The methods are directed to the detection of target analytes. By “target analytes” or grammatical equivalents herein is meant any molecule or compound to be detected. As outlined below, target analytes preferably bind to binding ligands, as is more fully described below. As will be appreciated by those in the art, a large number of analytes may be detected using the present methods; basically, any target analyte for which a binding ligand, described below, may be made may be detected using the methods of the invention.

Suitable analytes include organic and inorganic molecules, including biomolecules. In a preferred embodiment, the analyte may be an environmental pollutant (including pesticides, insecticides, toxins, etc.); a chemical (including solvents, organic materials, etc.); therapeutic molecules (including therapeutic and abused drugs, antibiotics, etc.); biomolecules (including hormones, cytokines, proteins, lipids, carbohydrates, cellular membrane antigens and receptors (neural, hormonal, nutrient, and cell surface receptors) or their ligands, etc); whole cells (including procaryotic (such as pathogenic bacteria) and eucaryotic cells, including mammalian tumor cells); viruses (including retroviruses, herpesviruses, adenoviruses, lentiviruses, etc.); and spores; etc. Particularly preferred analytes are environmental pollutants; nucleic acids; proteins (including enzymes, antibodies, antigens, growth factors, cytokines, etc); therapeutic and abused drugs; cells; and viruses.

Particularly preferred target analytes include proteins and nucleic acids. “Protein” as used herein includes proteins, polypeptides, and peptides. The protein may be made up of naturally occurring amino acids and peptide bonds, or synthetic peptidomimetic structures. The side chains may be in either the (R) or the (S) configuration. In the preferred embodiment, the amino acids are in the (S) or L-configuration. If non-naturally occurring side chains are used, non-amino acid substituents may be used, for example to prevent or retard in vivo degradations.

By “nucleic acid” or “oligonucleotide” or grammatical equivalents herein means at least two nucleotides covalently linked together. A nucleic acid of the present invention will generally contain phosphodiester bonds, although in some cases, as outlined below, nucleic acid analogs are included that may have alternate backbones, comprising, for example, phosphoramide (Beaucage et al., Tetrahedron 49(10):1925 (1993) and references therein; Letsinger, J. Org. Chem. 35:3800 (1970); Sprinzl et al., Eur. J. Biochem. 81:579 (1977); Letsinger et al., Nucl. Acids Res. 14:3487 (1986); Sawai et al, Chem. Lett. 805 (1984), Letsinger et al., J. Am. Chem. Soc. 110:4470 (1988); and Pauwels et al., Chemica Scripta 26:141 91986)), phosphorothioate (Mag et al., Nucleic Acids Res. 19:1437 (1991); and U.S. Pat. No. 5,644,048), phosphorodithioate (Briu et al., J. Am. Chem. Soc. 111:2321 (1989), O-methylphophoroamidite linkages (see Eckstein, Oligonucleotides and Analogues: A Practical Approach, Oxford University Press), and peptide nucleic acid backbones and linkages (see Egholm, J. Am. Chem. Soc. 1 14:1895 (1992); Meier et al., Chem. Int. Ed. Engl. 31:1008 (1992); Nielsen, Nature, 365:566 (1993); Carlsson et al., Nature 380:207 (1996), all of which are incorporated by reference). Other analog nucleic acids include those with bicyclic structures including locked nucleic acids, Koshkin et al., J. Am. Chem. Soc. 120:13252-3 (1998); positive backbones (Denpcy et al., Proc. Natl. Acad. Sci. USA 92:6097 (1995); non-ionic backbones (U.S. Pat. Nos. 5,386,023, 5,637,684, 5,602,240, 5,216,141 and 4,469,863; Kiedrowshi etal., Angew. Chem. Intl. Ed. English 30:423 (1991); Letsinger et al., J. Am. Chem. Soc. 110:4470 (1988); Letsinger et al., Nucleoside & Nucleotide 13:1597 (1994); Chapters 2 and 3, ASC Symposium Series 580, “Carbohydrate Modifications in Antisense Research”, Ed. Y. S. Sanghui and P. Dan Cook; Mesmaeker et al., Bioorganic & Medicinal Chem. Lett. 4:395 (1994); Jeffs et al., J. Biomolecular NMR 34:17 (1994); Tetrahedron Lett. 37:743 (1996)) and non-ribose backbones, including those described in U.S. Pat. Nos. 5,235,033 and 5,034,506, and Chapters 6 and 7, ASC Symposium Series 580, “Carbohydrate Modifications in Antisense Research”, Ed. Y. S. Sanghui and P. Dan Cook. Nucleic acids containing one or more carbocyclic sugars are also included within the definition of nucleic acids (see Jenkins et al., Chem. Soc. Rev. (1995) pp169-176). Several nucleic acid analogs are described in Rawls, C & E News Jun. 2, 1997 page 35. All of these references are hereby expressly incorporated by reference. These modifications of the ribose-phosphate backbone may be done to facilitate the addition of ETMs, or to increase the stability and half-life of such molecules in physiological environments.

As will be appreciated by those in the art, all of these nucleic acid analogs may find use in the present invention. In addition, mixtures of naturally occurring nucleic acids and analogs can be made. Alternatively, mixtures of different nucleic acid analogs, and mixtures of naturally occuring nucleic acids and analogs may be made.

Particularly preferred are peptide nucleic acids (PNA) which includes peptide nucleic acid analogs. These backbones are substantially non-ionic under neutral conditions, in contrast to the highly charged phosphodiester backbone of naturally occurring nucleic acids. This results in two advantages. First, the PNA backbone exhibits improved hybridization kinetics. PNAs have larger changes in the melting temperature (Tm) for mismatched versus perfectly matched basepairs. DNA and RNA typically exhibit a 2-4° C. drop in Tm for an internal mismatch. With the non-ionic PNA backbone, the drop is closer to 7-9° C. This allows for better detection of mismatches. Similarly, due to their non-ionic nature, hybridization of the bases attached to these backbones is relatively insensitive to salt concentration.

The nucleic acids may be single stranded or double stranded, as specified, or contain portions of both double stranded or single stranded sequence. The nucleic acid may be DNA, both genomic and cDNA, RNA or a hybrid, where the nucleic acid contains any combination of deoxyribo- and ribo-nucleotides, and any combination of bases, including uracil, adenine, thymine, cytosine, guanine, inosine, xanthine hypoxanthine, isocytosine, isoguanine, etc. A preferred embodiment utilizes isocytosine and isoguanine in nucleic acids designed to be complementary to other probes, rather than target sequences, as this reduces non-specific hybridization, as is generally described in U.S. Pat. No. 5,681,702. As used herein, the term “nucleoside” includes nucleotides as well as nucleoside and nucleotide analogs, and modified nucleosides such as amino modified nucleosides. In addition, “nucleoside” includes non-naturally occuring analog structures. Thus for example the individual units of a peptide nucleic acid, each containing a base, are referred to herein as a nucleoside.

The present system finds particular utility in array formats, i.e. wherein there is a matrix of addressable detection electrodes (herein generally referred to “pads”, “addresses” or “micro-locations”). By “array” herein is meant a plurality of capture ligands in an array format; the size of the array will depend on the composition and end use of the array. Arrays containing from about 2 different capture ligands to many thousands can be made. Generally, the array will comprise from two to as many as 100,000 or more, depending on the size of the electrodes, as well as the end use of the array. Preferred ranges are from about 2 to about 10,000, with from about 5 to about 1000 being preferred, and from about 10 to about 100 being particularly preferred. In some embodiments, the compositions of the invention may not be in array format; that is, for some embodiments, compositions comprising a single capture ligand may be made as well. In addition, in some arrays, multiple substrates may be used, either of different or identical compositions. Thus for example, large arrays may comprise a plurality of smaller substrates.

By “electrode” herein is meant a composition, which, when connected to an electronic device, is able to sense a current or charge and convert it to a signal. Preferred electodes are known in the art and include, but are not limited to, certain metals and their oxides, including gold; platinum; palladium; silicon; aluminum; metal oxide electrodes including platinum oxide, titanium oxide, tin oxide, indium tin oxide, palladium oxide, silicon oxide, aluminum oxide, molybdenum oxide (Mo₂O₆), tungsten oxide (WO₃) and ruthenium oxides; and carbon (including glassy carbon electrodes, graphite and carbon paste). Preferred electrodes include gold, silicon, carbon and metal oxide electrodes.

The electrodes described herein are depicted as a flat surface, which is only one of the possible conformations of the electrode and is for schematic purposes only. The conformation of the electrode will vary with the detection method used. For example, flat planar electrodes may be preferred for optical detection methods, or when arrays of nucleic acids are made, thus requiring addressable locations for both synthesis and detection. Alternatively, for single probe analysis, the electrode may be in the form of a tube, with the conductive oligomers and nucleic acids bound to the inner surface. This allows a maximum of surface area containing the nucleic acids to be exposed to a small volume of sample.

In a preferred embodiment, the detection electrodes are formed on a substrate. In addition, the discussion herein is generally directed to the formation of gold electrodes, but as will be appreciated by those in the art, other electrodes can be used as well. The substrate can comprise a wide variety of materials, as will be appreciated by those in the art, with printed circuit board (PCB) materials being particularly preferred. Thus, in general, the suitable substrates include, but are not limited to, fiberglass, teflon, ceramics, glass, silicon, mica, plastic (including acrylics, polystyrene and copolymers of styrene and other materials, polypropylene, polyethylene, polybutylene, polycarbonate, polyurethanes, Teflon™, and derivatives thereof, etc.), GETEK (a blend of polypropylene oxide and fiberglass), etc.

In general, preferred materials include printed circuit board materials and silicon and glass. The detection electrode comprises a self-assembled monolayer (SAM). By “monolayer” or “self-assembled monolayer” or “SAM” herein is meant a relatively ordered assembly of molecules spontaneously chemisorbed on a surface, in which the molecules have a preferred orientation relative to each other (e.g. are oriented approximately parallel to each other) and a preferred orientation relative to the surface (e.g. roughly perpendicular to it). Each of the molecules includes a functional group that adheres to the surface, and a portion that interacts with neighboring molecules in the monolayer to form the relatively ordered array. A “mixed” monolayer comprises a heterogeneous monolayer, that is, where at least two different molecules make up the monolayer. As outlined herein, the efficiency of target analyte binding (for example, oligonucleotide hybridization) may increase when the analyte is at a distance from the electrode. Similarly, non-specific binding of biomolecules, including the target analytes, to an electrode is generally reduced when a monolayer is present. Thus, a monolayer facilitates the maintenance of the analyte away from the electrode surface. In addition, a monolayer serves to keep extraneous electroactive species away from the surface of the electrode.

The SAMs of the invention have the general formula R—(CR₁R₂)₂—X, wherein R, R₁ and R₂ are independently substitution groups as outlined below. However, as will be appreciated by those in the art, the SAM may also comprise other types of alkyl groups, including alkenyl, alkynl, and aryl groups, so long as a SAM can be formed. In addition, any part of the SAM may include additional R groups or heteroatom groups, such as those shown in FIG. 7. For example, the SAM can have the formula R-(SAM forming species)-X.

Suitable R groups include, but are not limited to, hydrogen, alkyl, alcohol, aromatic, amino, amido, nitro, ethers, esters, aldehydes, sulfonyl, silicon moieties, halogens, sulfur containing moieties, phosphorus containing moieties, and ethylene glycols. In the structures depicted herein, R is hydrogen when the position is unsubstituted. It should be noted that some positions may allow two substitution groups, R and R′, in which case the R and R′ groups may be either the same or different.

By “alkyl group” or grammatical equivalents herein is meant a straight or branched chain alkyl group, with straight chain alkyl groups being preferred. If branched, it may be branched at one or more positions, and unless specified, at any position. The alkyl group may range from about 1 to about 30 carbon atoms (C1-C30), with a preferred embodiment utilizing from about 1 to about 20 carbon atoms (C1-C20), with about C1 through about C12 to about C15 being preferred, and C1 to C5 being particularly preferred, although in some embodiments the alkyl group may be much larger. Alkyl includes alkane, alkene, alkyne and allyl groups. Also included within the definition of an alkyl group are cycloalkyl groups such as C5 and C6 rings, and heterocyclic rings with nitrogen, oxygen, sulfur or phosphorus. Alkyl also includes heteroalkyl, with heteroatoms of sulfur, oxygen, nitrogen, and silicone being preferred. Alkyl includes substituted alkyl groups. By “substituted alkyl group” herein is meant an alkyl group further comprising one or more substitution moieties “R”, as defined above.

By “aryl” or “aromatic group” or grammatical equivalents herein is meant an aromatic monocyclic or polycyclic hydrocarbon moiety generally containing 5 to 14 carbon atoms (although larger polycyclic rings structures may be made) and any carbocylic ketone or thioketone derivative thereof, wherein the carbon atom with the free valence is a member of an aromatic ring. Aromatic groups include arylene groups and aromatic groups with more than two atoms removed. For the purposes of this application aromatic includes heterocycle. “Heterocycle” or “heteroaryl” means an aromatic group wherein 1 to 5 of the indicated carbon atoms are replaced by a heteroatom chosen from nitrogen, oxygen, sulfur, phosphorus, boron and silicon wherein the atom with the free valence is a member of an aromatic ring, and any heterocyclic ketone and thioketone derivative thereof. Thus, heterocycle includes thienyl, furyl, pyrrolyl, pyrimidinyl, oxalyl, indolyl, purinyl, quinolyl, isoquinolyl, thiazolyl, imidozyl, etc.

By “amino groups” or grammatical equivalents herein is meant —NH₂, —NHR and —NR₂ groups, with R being as defined herein.

By “nitro group” herein is meant an —NO₂ group.

By “sulfur containing moieties” herein is meant compounds containing sulfur atoms, including but not limited to, thia-, thio- and sulfo- compounds, thiols (—SH and —SR), and sulfides (—RSR—). By “phosphorus containing moieties” herein is meant compounds containing phosphorus, including, but not limited to, phosphines and phosphates. By “silicon containing moieties” herein is meant compounds containing silicon.

By “ether” herein is meant an —O—R group. Preferred ethers include alkoxy groups, with —O—(CH₂)₂CH₃ and —O—(CH₂)₄CH₃ being preferred.

By “ester” herein is meant a —COOR group.

By “halogen” herein is meant bromine, iodine, chlorine, or fluorine. Preferred substituted alkyls are partially or fully halogenated alkyls such as CF₃, etc.

By “aldehyde” herein is meant —RCOH groups.

By “alcohol” herein is meant —OH groups, and alkyl alcohols —ROH.

By “amido” herein is meant —RCONH— or RCONR— groups.

By “ethylene glycol” or “(poly)ethylene glycol” herein is meant a —(O—CH₂—CH₂)ₙ— group, although each carbon atom of the ethylene group may also be singly or doubly substituted, i.e. —(O—CR₂—CR₂)ₙ—, with R as described above. Ethylene glycol derivatives with other heteroatoms in place of oxygen (i.e. —(N—CH₂—CH₂)ₙ— or —(S—CH₂—CH₂)ₙ—, or with substitution groups) are also preferred.

For the R groups outlined herein, the R group at the terminus of the SAM is particularly important as the polymerizable group to add additional moieties to the surface of the SAM. These polymerizable groups fall into two main categories; those that allow the polymerization of “gel pad” type polymers, such as acrylamide based polymers, and those that allow the polymerization of conjugated polymers.

In a preferred embodiment, for gel pad embodiments, preferably R is an acrylate, acrylamide, allyl, acryloxy, epoxy, aLkyl, aLkenyl, aLkynyl, maleimido, Nisopropylacrylamide or cyano group. Most preferably, R is an acrylamide group.

In a preferred embodiment, for conjugated polymer embodiments, preferably R is a precursor to a charge neutral conjugated polymer. A charge neutral conjugated polymer is meant a polymer with zero charge (negative or positive) on its backbone, yet with delocalized pi electron on its backbone. A conjugated polymer is characterized by its backbone with regular alternation of single and double chemical bonds. Examples of conjugated polymers include: polypyrrole, polyphenylene, polyacetylene, polydiacetylene, polythiophene, polyfuran, polyaniline, polycarbazole, poly(phenylene vinylene). Thus any precursor to these polymers can serve as the terminal R group. More specifically, the invention encompasses a charge neutral conjugated polymers containing one or more functional groups capable of binding a probe molecule. The charge neutral conjugated polymer deposited on the surface of electrodes by electrochemical copolymerization of aromatic monomers and functionalized monomers as is known in the art. See generally PCT US00/15832, hereby incorporated by reference in its entirety.

In a preferred embodiment, the R group on the surface of the SAM is the charge neutral conjugated polymer, that is essentially linked at a plurality of locations to the electrode or metal surface using a SAM linker.

In a preferred embodiment, the detection electrode further comprises a capture binding ligand. In general, these capture binding ligands are attached to the polymer on the surface of the SAM. By “binding ligand” or “binding species” herein is meant a compound that is used to probe for the presence of the target analyte, that will bind to the target analyte.

Generally, the capture binding ligand allows the attachment of a target analyte to the detection electrode, for the purposes of detection.

In a preferred embodiment, the binding is specific, and the binding ligand is part of a binding pair. By “specifically bind” herein is meant that the ligand binds the analyte, with specificity sufficient to differentiate between the analyte and other components or contaminants of the test sample. However, as will be appreciated by those in the art, it will be possible to detect analytes using binding that is not highly specific; for example, the systems may use different binding ligands, for example an array of different ligands, and detection of any particular analyte is via its “signature” of binding to a panel of binding ligands, similar to the manner in which “electronic noses” work. The binding should be sufficient to allow the analyte to remain bound under the conditions of the assay, including wash steps to remove non-specific binding. In some embodiments, for example in the detection of certain biomolecules, the binding constants of the analyte to the binding ligand will be at least about 10⁻⁴ to 10⁻⁶ M⁻¹, with at least about 10⁻⁵ to 10⁻⁹ being preferred and at least about 10⁻⁷ to 10⁻⁹ M⁻¹ being particularly preferred.

As will be appreciated by those in the art, the composition of the binding ligand will depend on the composition of the target analyte. Binding ligands to a wide variety of analytes are known or can be readily found using known techniques. For example, when the analyte is a single-stranded nucleic acid, the binding ligand is generally a substantially complementary nucleic acid. Alternatively, as is generally described in U.S. Pat. Nos. 5,270,163, 5,475,096, 5,567,588, 5,595,877, 5,637,459, 5,683,867, 5,705,337, and related patents, hereby incorporated by reference, nucleic acid “aptomers” can be developed for binding to virtually any target analyte. Similarly the analyte may be a nucleic acid binding protein and the capture binding ligand is either a single-stranded or double-stranded nucleic acid; alternatively, the binding ligand may be a nucleic acid binding protein when the analyte is a single or double-stranded nucleic acid. When the analyte is a protein, the binding ligands include proteins (particularly including antibodies or fragments thereof (FAbs, etc.)), small molecules, or aptamers, described above. Preferred binding ligand proteins include peptides. For example, when the analyte is an enzyme, suitable binding ligands include substrates, inhibitors, and other proteins that bind the enzyme, i.e. components of a multi-enzyme (or protein) complex. As will be appreciated by those in the art, any two molecules that will associate, preferably specifically, may be used, either as the analyte or the binding ligand. Suitable analyte/binding ligand pairs include, but are not limited to, antibodies/antigens, receptors/ligand, proteins/nucleic acids; nucleic acids/nucleic acids, enzymes/substrates and/or inhibitors, carbohydrates (including glycoproteins and glycolipids)/lectins, carbohydrates and other binding partners, proteins/proteins; and protein/small molecules. These may be wild-type or derivative sequences. In a preferred embodiment, the binding ligands are portions (particularly the extracellular portions) of cell surface receptors that are known to multimerize, such as the growth hormone receptor, glucose transporters (particularly GLUT4 receptor), transferrin receptor, epidermal growth factor receptor, low density lipoprotein receptor, high density lipoprotein receptor, leptin receptor, interleukin receptors including IL-1, IL-2, IL-3, IL-4, IL-5, IL-6, IL-7, IL-8, IL-9, IL-11, IL-12, IL-13, IL-15 and IL-17 receptors, VEGF receptor, PDGF receptor, EPO receptor, TPO receptor, ciliary neurotrophic factor receptor, prolactin receptor, and T-cell receptors. Similarly, there is a wide body of literature relating to the development of binding partners based on combinatorial chemistry methods.

In this embodiment, when the binding ligand is a nucleic acid, preferred compositions and techniques are outlined in WO 98/20162; PCT/US98/12430; PCT/US98/12082; PCT/US99/01705; PCT/US99/01703; and U.S. Ser. Nos. 09/135,183; 60/105,875; and 09/295,691, all of which are hereby expressly incorporated by reference.

The method of attachment of the polymer (or polymer precursor, e.g. a polymerizable group or monomer) to the SAM forming moiety will generally be done as is known in the art, and will depend on both the composition of the SAM and the polymer. In general, the polymers are attached to the SAM through the use of functional groups on each that can then be used for attachment. Preferred functional groups for attachment are amino groups, carboxy groups, oxo groups and thiol groups. These functional groups can then be attached, either directly or indirectly through the use of a linker, sometimes depicted herein as “Z”. Linkers are well known in the art; for example, homo-or hetero-bifunctional linkers as are well known (see 1994 Pierce Chemical Company catalog, technical section on cross-linkers, pages 155-200, incorporated herein by reference). Preferred Z linkers include, but are not limited to, alkyl groups (including substituted alkyl groups and alkyl groups containing heteroatom moieties), with short alkyl groups, esters, amide, amine, epoxy groups and ethylene glycol and derivatives being preferred, with propyl, acetylene, and C₂ alkene being especially preferred. Z may also be a sulfone group, forming sulfonamide linkages.

In addition, these same methods of attachment (e.g. the addition of functional groups) to the polymers and capture binding ligands can be done.

It should also be noted that the order of attachment can be varied. For example, in some circumstances, the SAM comprising a polymerizable moiety is added to the metal surface, then polymerization occurs, followed by the attachment of the capture binding ligands. Alternatively, the SAM comprising a functional group is added to the metal surface, followed by the addition of either a polymerized layer comprising the capture binding ligands, or the ligands are added later. As will be appreciated by those in the art, other variations are possible as well. The former is preferred.

In this way, capture binding ligands comprising proteins, lectins, nucleic acids, small organic molecules, carbohydrates, etc. can be added.

A preferred embodiment utilizes proteinaceous capture binding ligands. As is known in the art, any number of techniques may be used to attach a proteinaceous capture binding ligand to an attachment linker. A wide variety of techniques are known to add moieties to proteins.

A preferred embodiment utilizes nucleic acids as the capture binding ligand. While most of the following discussion focuses on nucleic acids, as will be appreciated by those in the art, many of the techniques outlined below apply in a similar manner to non-nucleic acid systems as well.

One key feature of biochips is the manner in which the arrayed biomolecules are attached to the surface of the biochip. Conventionally such procedures involve multiple reaction steps, often requiring chemical modification of the solid support itself. Even in embodiments comprising absorption matrices, such as hydrogels, present on a solid support, chemical modification of the gel polymer is necessary to provide a chemical functionality capable forming a covalent bond with the biomolecule. The efficiency of the attachment chemistry and strength of the chemical bonds formed are critical to the fabrication and ultimate performance of the micro array.

Polyacrylamide hydrogels and gel pads are often used as binding layers to adhere to surfaces biological molecules including, but not limited to, proteins, peptides, oligonucleotides, polynucleotides, and larger nucleic acid fragments. The methods of the present invention are directed to improving the adhesion of the gel pads to a metal-coated substrate surface, such that the biochip is advantageously used for performing assays that use optical and/or electrical detection methods.

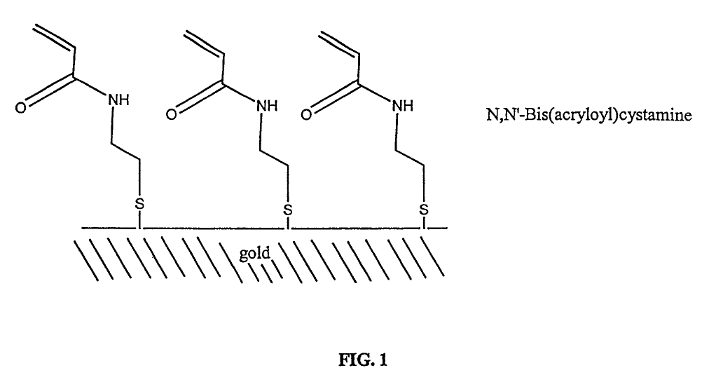

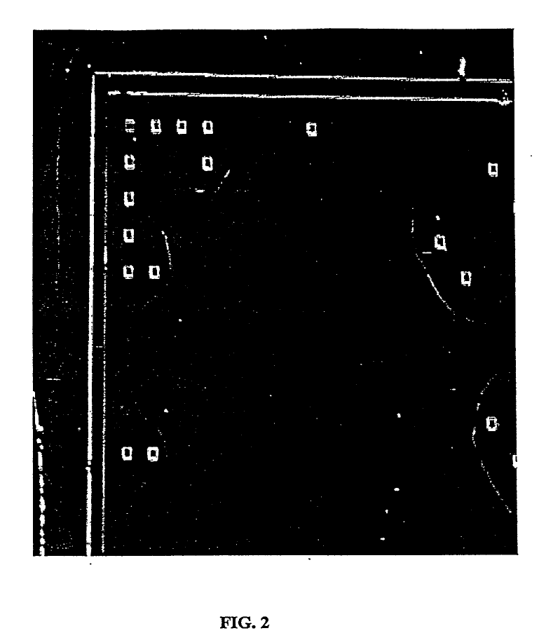

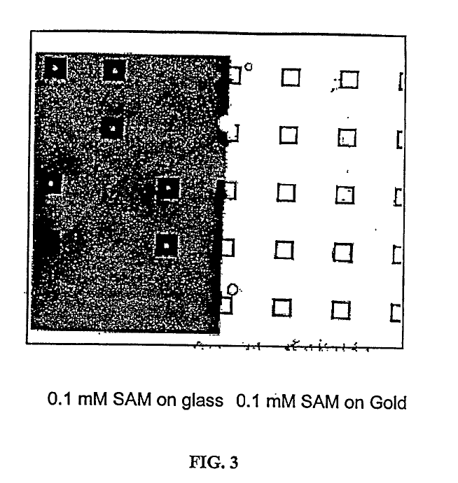

FIG. 1 illustrates a biochip 10 prepared according to the methods of the invention. The device 10 comprises a substrate 12 having a surface 14, a metal layer 16 deposited on the substrate surface 14, a self-assembled monolayer 18 deposited on the metal layer 16 and a polymer gel 20 deposited on self-assembled monolayer 18.

Substrate 12 is preferably composed of silicon, glass or plastic. Glass and plastic are particularly preferred for their low cost compared to silicon. Most preferably, the substrate 12 is glass. Preferably, substrate 12 has a thickness from about 1.0 to about 1.5 mm, more preferably from about 1.0 to 1.3 mm, and most preferably from about 1.1 to 1.2 mm. Numerous geometries are available for the substrate 12, including, but not limited to, rectangular substrates such as standard microscope slides, square substrates, and circular substrates such as silicon wafers. In embodiments having rectangular geometries, the dimensions of the substrate 12 are preferably between 25 mm wide by 75 mm long and 325 mm long by 350 mm wide. Most preferably, substrate 12 is 25 mm wide by 75 mm long. In embodiments having circular geometries, the substrate 12 preferably has a diameter of between 75 mm and 300 mm, more preferably between 75 and 150 mm, and most preferably about 100 mm. The substrate 12, however, is not limited to a specific geometry or set of dimensions, but may include additional geometries, including circular substrates, and dimensions.

The metal layer 16 is preferably composed of a noble metal, and most preferably is gold. The thickness of metal layer 16 is preferably from about 80 to about 500 nm, more preferably from about 90 to about 100 nm, and most preferably from about 99 to about 100 nm.

The self-assembled monolayer 18 is preferably composed of a bifunctional molecule having the formula R—(CR₁R₂)₂—X, where R is a polymerizable group and X is a group that bonds to noble metals. Preferably R is an acrylate, acrylamide, allyl, acryloxy, epoxy, aLkyl, aLkenyl, aLkynyl, maleimido, Nisopropylacrylamide or cyano group. Most preferably, R is an acrylamide group. The X group is preferably selected from the following groups: —SH, —SeH, —TeH, —Se—SeR, —Te—TeR′, —SR′—SH, R′Si, —SO3H, —PO3H and —CO3H, NH2, where R′ and R″ are aL˜cyl groups, most preferably lower alkyl (i.e., comprising one to about 6 carbon atoms). Preferably, X is —SR′—SR″ or —SR′. Even more preferably, X is —SR′—SH or —SH. In embodiments where X is —SR′—SH, the selfassembled monolayer may form by attachment of both S molecules to the metal surface. Preferably n is between 1 and 30, more preferably between 6 and 16, and most preferably between 10 and 15. Most preferably, the bifunctional molecule is N,N′-bis(acryloyl)cystamine.

The gel 20 polymerized on top of the self-assembled layer allows for ion diffusion and facilitates electrochemical detection. Preferably, the gel is a hydrogel, and most preferably the gel is-a polyacrylamide gel. In a particularly preferred embodiment, gel 20 is a streptavidin containing polyacrylamide gel. Preferably, the gel is deposited as an array of gel pads; however, the invention is not limited to this arrangement. The gel pads are preferably square, but other geometries are also useful. The array of gel pads preferably has a spacing of between 100 and ˜, 600 }rm, more preferably between 250 ˜m and 300 1 lm, and most preferably about 300, ˜m. Square gel pads preferably have dimensions of between about 200 and 400 ˜m more preferably between about and 250 1 lm and 300 1 lm square, and most preferably about 100 ˜un square. Circular gel pads are preferably between about 100 1lm and 300 1lm in diameter, more preferably between about 100 ˜m and 200 1 lm in diameter, and most preferably between about 150 1 lm in diameter.

The first step of the methods of the present invention is the deposition of the metal layer 16 onto the substrate surface 14. The metal˜layer 16 may be deposited by a variety of methods including, but not limited to, vacuum deposition, sputtering, vapor deposition, and plasma enhanced vapor deposition. Preferably, the metal layer is formed by vacuum deposition in a deposition chamber such as the Temescal BJD 1800 Evapora˜or. Those of skill in the art will recognize the appropriate conditions for depositing a desired thickness of metal.

Prior to deposition of the metal layer 16, a layer of seed metal 15 may be deposited on the substrate surface 14. Preferably, the seed metal layer 15 is a layer of biocompatible metal Most preferably, the seed metal layer 15 is titanium. Preferably, the seed metal layer is deposited by vacuum deposition as described above.

Once the metal layer 16 has been deposited on the substrate surface 14, the selfassembled monolayer 18 is formed on the metal-coated substrate (Step 104). In particularly preferred embodiments, the self-assembled monolayer is formed by adsorbing thiol or disulfide groups onto a gold-coated substrate. The adsorption of thiols and disulfides from solution onto gold substrates is a well-characterized process. See, e.g., Uhlman, A. Chem. Rev. 1996, 96, 1533-1544; Bain, C. D. et al., J. Am. Chem. Soc. 1989, 111, 321-325; Ntl7,o, R. G. and Allara, D. L., J. An˜Chem. Soc. 1983, 105, 4481 4483; Troughton, E. B., et al. Lang˜nuir 1988, 4, 365 385; and Schoenfisch, M. H. and Pemberton, J. E. J. Am. Chem. Soc. 1988, 120, 4502-4513.

Once the metal coated substrate surface 14 has incubated in a solution containing the thiol or disulfide bifunctional group, a contact angle measurement is performed to rapidly assess whether the self-assembled monolayer 18 has formed. Preferably the measured contact angle will be between 55-70°. Troughton E. B., et al. Langmuir 1988, 4, 365-385. Low or high values tend to indicate the absence or presence of impurities on the surface.

The final step in the methods of the present invention is the formation of the gel pad 20 on the self-assembled monolayer 18. Preferably the gel pads 20 are composed of a material that copolymerizes with the self-assembled monolayer 18. The gel pads 20 of the present invention are conveniently produced as thin sheets or slabs, typically by depositing a solution of acrylamide monomer, a crosslinker such as methylene bisacrylamide, a catalyst such as N, N, N′, -tetramethylethylenediamine (TEMED) and an initiator such as ammonium persulfate for chemical polymerization, or 2,2-dimethoxy-2-phenyl-acetophone (DMPAP) for photopolymerization, in between the substrate and a quartz slide using a spacer to obtain the desired thickness of polyacrylamide gel. Generally, the acrylamide monomer and crosslinker are prepared in one solution of about 4-5% acrylamide (having an acrylamide/bisacrylarnide ratio of 19/1) in water/glycerol, with a nominal amount of initiator added. The solution is poly˜nerized and crosslir˜ked either by ultraviolet (W) radiation (e.g., 254 nm for at least about 15 minutes, or other appropriate W conditions, collectively termed “photopolymerization”), or by thermal initiation at elevated temperature (e.g., typically at about 40° C.). Following polymerization and crosslinking, the quartz slide is separated from the substrate to uncover the gel. The pore size (and hence the “sieving properties”) of the gel is controlled by changing the amount of crosslinker and the percent monomer in- the solution. The pore size also can be controlled by changing the polymerization temperature, time of W exposure, and power of W tool.

In the fabrication of polyacrylamide hydrogel arrays (i.e., patterned gels) used as binding layers for biological molecules, the acrylamide solution typically is imaged through a mask (preferably made of quartz) during the W polymerization/crosslinking step. The top quartz slide is removed after polymerization, and the unpolymerized monomer is developed with water, leaving a fine feature pattern of polyacrylamide hydrogel, which constitute the crosslinked polyacrylamide hydrogel pads. Further, in an application of lithographic techniques known in the semiconductor industry, light can be applied to discrete locations on the surface of a polyacrylamide hydrogel to activate these specified regions for the attachment of an oligonucleotide, an antibody, an antigen, a hormone, hormone receptor, a ligand or a polysaccharide on the surface (e.g., a polyacrylamide hydrogel surface) of a solid support (see, e.g, PCT Publication No. WO 91/07087, incorporated herein by reference).

Following formation of the gel pad 20 array, a corresponding array of oligonucleotide probes is attached to the gel pads 20. For hydrogel-based arrays using polyacrylamide, biomolecules (such as oligonucleotides) are covalently attached by forming an amide, ester or disulfide bond between the biomolecule and a derivatized polymer comprising the cognate chemical group. Covalent attachment of the biomolecule to the polymer is usually performed after polymerization and chemical cross-linking of the polymer is completed

Alternatively, oligonucleotides bearing S′-terminal acrylamide modifications can be used that eff˜ciently copolymerize with acrylamide monomers to form DNA-containing polyacrylamide copolymers (Rehman et al., Nucleic Acids Res. 1999, 27: 649-655). Using this approach, stable probe-containing layers can be fabricated on supports (e.g., microtiter plates and silanized ˜ss) having exposed acrylic groups. This approach has made available the commercially marketed “Acrydite=” capture probes (available from Mosaic Technologies, Boston, Mass.). The Acrydite moiety is a phosporamidite that contains an ethylene group capable of free-radical copolymerization with acrylamide, and which can be used in standard DNA synthesizers to introduce copolymerizable groups at the 5′ terminus of any oligonucleotide probe.

Following attachment of the biomolecules to the gel pad 20 array, the device is complete and comprises a substrate 12 having a surface 14, a metal layer 16 deposited on the substrate surface 14, a self-assembled monolayer 18 deposited on the metal layer 16. an array of polymer gel pads 20 deposited on self-assembled monolayer 18, and a corresponding array of biomolecules 22 attached to the array of gel pads 20.

The Examples that follow are illustrative of specific embodiments of the invention and various uses thereo£ They are set forth for explanatory purposes only, and are not to be taken as limiting the invention.

### EXAMPLE 1

### Preparation of a Gold-Coated Substrate

A standard glass microscope slide was oxygen plasma cleaned for 15 minutes in a Branson 4000 asher/etcher. The temperature in the plasma cleaner was ramped from room I temperature to 190° C. over 10 minutes while the pressure in the chamber was maintained at 1.2 torr.

The cleaned slide was then placed in a Temescal BJD 1800 Evaporator at room temperature and 2×10˜ torr with 1 gram of titanium. The slide was maintained in the evaporator˜for 20 seconds resulting in the deposition of a 5 nm layer of titanium on the slide. A layer of gold was then thermally deposited on the Ti layer in the Temescal evaporator using 2 grams of gold. The slide was maintained in the evaporator for 1000 seconds at room temperature and a pressure of 2×10˜ torr, resulting in the deposition of a 100 r˜m layer of gold. The thickness of the gold layer was measured using a Detak Tencor P-2 long scan profiler. The gold plated slides were then oxygen plasma cleaned in the Branson 4000 over a 10 minute penod in which the temperature was ramped from room temperature to 190° C.

### EXAMPLE2

### Formation of a N,N′-Bis-Acryloyl-Cysta5iine Monolayer on the Gold Coated Substrate

A 1 mM solution of N,N′-bis-acryloyl-cystamine (Aldrich, Milwaukee, Wis.) was prepared in 99.9°/0 ethanol. The gold-coated slides prepared in Example 1 were incubated overnight in the N,N′-bis-acryloyl-cystamine solution at room temperature. The slides were incubated in the dark to prevent degradation of the N,N′-bis-acryloyl-cystamine. The slides were rinsed three times with acetone using a squirt bottle, and then spin dried in a WS-4000 GTFM LITE spinner at 1500 rpm for 1 minute under vacuum and N2. Then, 2 I1L dl FIX THIS water droplets were delivered with a burette connected to a needle on three areas of each substrate surface. The contact angle of the droplets with the monolayer on the slides was measured with a Rame-Hart Goniometer and compared with a 0.1 mM substrate as shown in Table 1.

TABLE 1
Area 1 mM monolayer substrate 0.1 mM monolayer substrate I

| | | |
|---|---|---|
| 1 | 77.8° | 70.7° |
| 2 | ˜˜76.2° | −72.6° |
| 3 | 79.3° | 74.9° |

### EXAMPLE 3

### Formation of Streptavidin Containing Polyacrylamide Gel Pads on N,N′-Bis-Acryloyl-Cystamine Monolayer

10 mg of N-Acryloxysuccinimide (Sigma-Aldrich) was dissolved in 72 l1L dimethyl sulfoxide (DMSO). Next, 10 pL of the resulting solution was then mixed with 200 IIL streptavadin stock solution (10 mg Streptavidin in 2.5 mL PBS pH7.6 (Sigma-Aldrich, Milwaukee Wis.) and allowed to react at room temperature for 2-3 hours. The solution was then centrifuged for 2 minutes at high speed to remove any precipitate. An acrylamidecontaining solution was prepared by dissolving 25 mg bis-acrylamide (Sigma-Aldrich Milwaukee Wis.) in 6 mL phosphate buffered saline (PBS) at a pH of 7.6. Next, 475 mg acrylamide was added to the resultant solution, and filtered through a 5 micron filter (ColeParmer, Chicago Ill.). 290 pL of the acrylamide-containing solution was rnLxed with 210 1L of the streptavidin-containing solution to produce a precursor gel solution.

0.6 1 L of 1 mM methylene blue and 1.8 pL of TEMED were added to 150 pL of the precursor solution and mixed gently. A quartz mask (100×100˜m pad size, 300˜m apart (Dupont Photomask) cover and shims were then put in place to define the desired thickness of the polymer film. The structure was then exposed to W light (17 mW/crn2) for 7 minutes at 34 m thickness in a Deep W Flood Tool (Optical Associates Incorporated). The mask cover and shims were removed under water and the slide was soaked for 10 minutes to allow salts and unpolymerized material to seep out. The slide was air dried and stored at ambient conditions.

### EXAMPLE4

### Adhesion of Streptavidin Containing Polyacrylamide Gel Pads to N,N′-Bis-Acryloyl-Cystamine Monolayer

Immediately after fabrication, visual inspection of the slide at 10× magnification indicated that 7% of total possible pads a&Bred to Au that did not have the self-assembled monolayer, as shown in [IG. 2, 45% of total possible pads a&Bred to glass and 100% of total possible pads a&Bred to Au with the self-assembled monolayer, as shown in EIG. 3. Almost all of the remaining gel pads on the untreated gold-coated substrate adhered close to the edge of the array. The slides were then subjected to mechanical agitation to determine stability of remaining gel pads, by placing the slide in a shaking water bath with an aqueous buffer containing detergent (1× saline sodium citrate, Sigma, and 0.1% sodium dodecyl sulfate, Sigma) at 80° C., and gently agitating the slide at 60 rpm. After 2 hours of agitation, all of the pads on the glass portion of the slide had delaminated, while none of the pads on the gold-coated slide with the self-assembled monolayer had delaminated.

### EXAMPLE 5

### Different Polypyrrole and Their Derivatives as Matrices for Bio-Electrical Detection

This invention proposes to use different polypyrrole and their derivatives as improved matrices for bio-electrical detection.

Preparation of Dipyrrole Derivatives as Crosslinkers for Polypyrrole Films

The current polypyrrole films are mainly comprised of pyrrole monomers forming a linear chain. Those structures are not very resilient and different layers could potentially slide and deform by time. The potential structural change of the polypyrrole film by time will ultimately change the electrochemical behavior, resulting in the change of the background of the electrical or electrochemical analysis on the polypyrrole film coated probes or chips. To overcome those potential problems, dipyrrole derivatives as crosslinkers were designed and synthesized. During copolymerization of dipyrrole linkers and regular pyrrole, one pyrrole moiety of the dipyrrole derivative will incorporate into one linear polypyrrole chain and another pyrrole head can incorporate into another chain. This will result in the formation of the web-like 3D polypyrrole film. The web-like polypyrrole film will have enhanced resilience to outside physical change, the sliding and deformation of the linear polypyrrole are expected to decrease significantly in the 3D polypyrrole. If sliding and deformation of the linear polypyrrole are the primary cause of the change of background by time for electrochemical analysis, it is expected that the 3D polypyrrole film will have much more stable background. Three dipyrrole derivatives have been prepared. The goal is to synthesize a more stable, water soluble crosslinker so it can be copolymerize with pyrrole in 1× PBS buffer, which is the normal polymerization condition for polypyrrole. Of all the three crosslinkers synthesized, dipyrrole acetic 4,7,10-trioxa-1,13-tridecanodiamide is found to be most stable, and water soluble compound.

This Synthesis of Dipyrrole Propylamide Tartarate is Shown in FIG. 4.

0.28 g d-tartaric acid was dissolved in 2 mL pyridine and 10 mL acetonitrile. 1 g pyrrole propylamine, 3 g BOP, 50 mg HBOP are added to the reaction mixture. The resulting mixture was stirred overnight. The product was purified by Silica gel and 4:1 methylene chloride:acetone. 250 mg product was obtained.

The Synthesis of 4, 7, 10-trioxa-1,13-tridecanodipyrrole is Shown in FIG. 5.

8 mL acetic acid, 8 mL water, 2.6 g 2,5-dimethoxytetrahydrofuran, 2.2 g 4,7,10-trioxa-1,13-tridecanodiamine was heated at 70° C. for 4 hour. The resulting solution was cooled down to room temperature and extracted with methylene chloride, and the organic layer was dried in anhydrous Magnesium Sulfate. The solvent was evaporated by vacuum and column chromatography is done by Silica gel and 10:1methylene chloride:ethyl acetate. 3 g pure product was obtained.

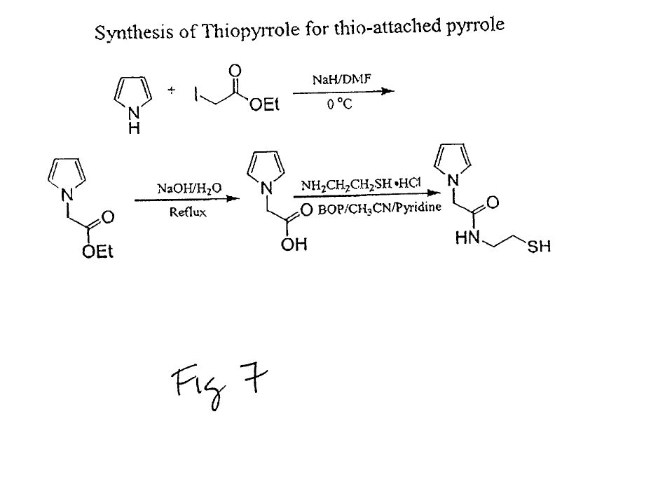

The Synthesis of Dipyrrole Acetic 4 7, 10-trioxa-1, 13-tridecanodiamide is Shown in FIG. 6.

0.45 g pyrrole acetic NHS ester, 200 mg 4,7,10-trioxa-1,13-tridecanodiamine were mixed in dry DMF and one equivalent amount of triethylamine. The reaction mixture was stirred at room temperature overnight. The solvent was evaporated and the crude compound was purified by column chromatography by Silica gel and acetone. 380 mg pure product was obtained.

### Preparation of Thiopyrrole for Enhanced Attachment on Chip Gold Surface

The regular polypyrrole attached on gold surface is based upon the weak interaction between nitrogen and gold. The delaminating of polypyrrole from the gold surface can be problematic due to physical force from solution and during analytical processes. Thiopyrrole was designed and synthesized to solve this problem. It is hoped that the sulfur-gold interaction could be covalent in nature and provide strong interaction between the polypyrrole and the gold surface. A variety of thiopyrrole derivatives can be prepared based on their chain length from pyrrole to the sulfur moiety, their water solubility. Below is one example of the thiopyrrole synthesis.

Synthesis of Thiopyrrole for Thio-Attached Pyrrole is Shown in FIG. 7.

2 g Sodium Hydride and 150 mL DMF was cooled in ice bath and stirred by a stirring bar. 5 g pyrrole was added gradually and foaming occurred during reaction. The reaction mixture was stirred for one hour after finishing adding NaH. 15.5 g ethyl iodoacetate was added gradually to the reaction mixture and the solution was stirred overnight. The reaction was quenched by brine, the crude product was extracted by ethyl acetate three times. The combined organic layer was dried by anhydrous MgSO₄. The solvent was evaporated in vacuum. The crude product was added to the 20 g potassium hydroxide and 100 mL water. The aqueous solution was refluxed overnight. The solution was cooled in ice bath and acidified by conc. HCl to pH 1-2, and it was extracted with ethyl acetate three times. The organic layer was washed by brine once and dried by anhydrous MgSO₄. The solvent was evaporated in vacuum and the crude product was purified by Silica gel and ethyl acetate. About 6 g pure pyrrole acetic acid was obtained.

1 g pyrrole acetic acid, 1.6 g 2-aminoethanethiol, 4.77 g BOP, 20 mg HBOP, 2 mL pyridine and 20 mL dry acetonitrile was mixed and stirred at room temperature overnight. The solvent was evaporated, and the compound was purified by column chromatography with 3:1 methylene chloride:ethyl acetate. 450 mg thio pyrrole was obtained.

It should be understood that the foregoing disclosure emphasizes certain specific embodiments of the invention and that all modifications or alternatives equivalent thereto are within the spirit and scope of the invention as set forth in the appended claims. All references are incorporated herein in their entirety.

In a preferred embodiment, electronic detection is used, including amperommetry, voltammetry, capacitance, and impedence. Suitable techniques include, but are not limited to, electrogravimetry; cou lometry (including controlled potential coulometry and constant current coulometry); voltametry (cyclic voltametry, pulse voltametry (normal pulse voltametry, square wave voltametry, differential pulse voltametry, Osteryoung square wave voltametry, and coulostatic pulse techniques); stripping analysis (aniodic stripping analysis, cathiodic stripping analysis, square wave stripping voltammetry); conductance measurements (electrolytic conductance, direct analysis); time-dependent electrochemical analyses (chronoamperometry, chronopotentiometry, cyclic chronopotentiometry and amperometry, AC polography, chronogalvametry, and chronocoulometry); AC impedance measurement; capacitance measurement; AC voltametry; and photoelectrochemistry.

What we claim is:

1. A method of adhering polymeric structures to a noble metal-coated substrate, comprising the steps of:
(a) adsorbing to the noble metal-coated substrate a bifunctional molecule having the formula R—(CR₁R₂)₂—X,
wherein
R is a polymerizable or cross-linkable molecule;
R₁ and R₂ are independent substitution groups
X is a group that bonds to noble metals,
thereby forming a monolayer of the bifunctional compound adsorbed to the noble-metal-coated substrate, and
(b) polymerizing a polymer on the monolayer.

2. The method of claim 1 wherein the noble metal is gold.

3. The method of claim 1 wherein R is a pyrrole derivative.

4. The method of claim 1 wherein R is an acrylate, acrylamide, allyl, acryloxy, epoxy, alkyl, alkenyl, alkynyl, maleimido or cyano group.

5. The method of claim 3 wherein R is —NHC(0)CHCH2.

6. The method of claim 1 wherein X is a thiol or cyano group.

7. The method of claim 1 wherein X is selected from the group consisting of —SH, SeH, —TeH, —Se—SeR′, —Te—TeR, —SR′—SR″, —S—R′, —SiR′, —SO3H, —PO3H and —CO3H, where R′ and R″ are substitution groups.

8. The method of claim 1 wherein X is —S—SR, n is 2 and R is —NHC(0)CHCH2.

9. The method of claim 1 wherein n is between 1 and 15.

10. The method of claim 1 wherein the hydrogel is a polyacrylamide hydrogel.

11. The method of claim 10 wherein the hydrogel is a streptavidin-containing polyacrylamide hydrogel.

12. The method of claim 1 wherein the hydrogel is composed of a material that copolymerizes with the self-assembled monolayer.

16. A method of adhering polymeric structures to a gold-coated substrate, comprising the steps of:
(a) adsorbing to the gold-coated substrate a layer of N,N′ Bis(acryloyl)cystamine, thereby forming a self-assembled monolayer;
(b) polymerizing. a hydrogel on the self-assembled monolayer of N,N′ Bis(acryloyl)cystarnine.

17. An apparatus for performing biological assays, comprising:
(a) a substrate having a surface;
(b) a noble metal layer deposited on the substrate surface;
(c) a self-assembled monolayer adsorbed on the noble metal layer comprised of a bifunctional molecule having the formula R—(CR₁R₂)₂—X,
wherein
R is a polymerizable or cross-linkable molecule;
R₁ and R₂ are independent substitution groups
X is a group that bonds to noble metals,
thereby forming a monolayer of the bifunctional compound adsorbed to the noble-metal-coated substrate, and
(d) a polymeric gel deposited on the self-assembled monolayer.
